(19) United States
(12) Patent Application Publication
(10) Pub. No.: US 2026/0346208 A1
(43) Pub. Date: Nov. 5, 2026

(54) PREPARATION METHOD OF CERAMIC MEMBRANE WITH HIGH-EFFICIENCY SEPARATION AND CATALYTIC FUNCTIONS AND PRODUCT THEREOF

(71) Applicant: JINGDEZHEN CERAMIC UNIVERSITY, Jingdezhen (CN)

(72) Inventors: Yulong YANG, Jingdezhen (CN); Qibing CHANG, Jingdezhen (CN); Zhiwen HU, Jingdezhen (CN); Yue ZHA, Jingdezhen (CN); Kaiqin LI, Jingdezhen (CN); Ruiqiang YANG, Jingdezhen (CN); Yongqing WANG, Jingdezhen (CN); Xiaozhen ZHANG, Jingdezhen (CN); Xuebing HU, Jingdezhen (CN); Lili ZHENG, Jingdezhen (CN); Min WANG, Jingdezhen (CN)

(73) Assignee: JINGDEZHEN CERAMIC UNIVERSITY, Jingdezhen (CN)

(21) Appl. No.: 19/708,867

(22) Filed: Jun. 15, 2026

Related U.S. Application Data
(63) Continuation of application No. PCT/CN2025/141030, filed on Dec. 9, 2025.

(30) Foreign Application Priority Data
Dec. 5, 2024 (CN) 202411775138.9

(51) Int. Cl. B01D 67/00; B01D 69/02; B01D 69/10; B01D 69/14; C02F 1/44; C02F 1/72; C02F 101/34

(52) U.S. Cl. CPC B01D 67/0046; B01D 69/02; B01D 69/105; B01D 69/108; B01D 69/145; B01D 2323/081; B01D 2325/02833; C02F 1/44; C02F 1/725; C02F 2101/34

(57) ABSTRACT

Provided is a preparation method of a ceramic membrane with high-efficiency separation and catalytic functions and a product thereof. A ceramic membrane support is prepared using large-particle-size ceramic particles as a raw material, an intermediate layer is prepared by a slurry dipping method using transition metal oxide nanofibers as a raw material, a separation membrane layer is prepared by a dip-coating method using fine ceramic particles as a raw material, and a ceramic membrane having a sandwich structure is formed through one-step co-firing. The transition metal oxide nanofibers are used to form the intermediate layer having a high porosity and a high specific surface area, thereby increasing the number of catalytic active sites and the permeation flux; fine ceramic particles are used to form the separation membrane layer having a uniform pore size distribution and a flat membrane surface, thereby improving the separation efficiency of particulate matter and organic matter in water and reducing the accumulation thereof on the membrane surface, while preventing the particulate matter and the organic matter in the water from covering the active sites of the catalytic ceramic membrane, thus achieving simultaneous improvement in the separation efficiency and the catalytic degradation efficiency of the ceramic membrane.

### CROSS-REFERENCE TO RELATED APPLICATIONS

This application is a Continuation of International Application No. PCT/CN2025/141030, filed on Dec. 9, 2025, which claims priority to Chinese Patent Application No. 202411775138.9, filed on Dec. 5, 2024, the entire contents of each of which are hereby incorporated by reference.

### TECHNICAL FIELD

The present disclosure relates to the technical field of membrane separation, and in particular to a preparation method of a ceramic membrane with high-efficiency separation and catalytic functions and a product thereof.

### BACKGROUND

Emerging contaminants (e.g., soluble organic matter) exist in various types of wastewater, seriously threatening ecological environment safety and human health. A catalytic ceramic membrane coupled with an advanced oxidation process is considered a viable technique for removing emerging contaminants from wastewater. However, for preparation of a traditional catalytic ceramic membrane, transition metal nano-powder is loaded inside membrane pores of a ceramic membrane. For example, a catalytic ceramic membrane is prepared using a metal precursor impregnation method. Consequently, a specific surface area and catalytic active sites of the catalytic ceramic membrane are relatively limited due to a relatively large particle size of the transition metal nano-powder after calcination. Thus, a reaction efficiency between reactive oxygen species (ROS) and emerging contaminant molecules is limited, and an emerging contaminant removal efficiency is relatively low.

Therefore, existing technologies use a nanofiber catalyst and a single-atom catalyst with a high specific surface area as a membrane layer, thereby increasing a number of active sites and a generation efficiency of ROS of a catalytic ceramic membrane and promoting efficient removal of emerging contaminants. However, wastewater often contains various types of organic matter and small particulate matter, and membrane fouling is inevitably caused during membrane operation. Consequently, catalytic active sites fail, and a contact efficiency between the catalytic active sites and an oxidant is reduced, severely limiting efficient removal of emerging contaminants in wastewater.

Particularly, when particulate matter, macromolecular organic substances, and emerging contaminants coexist in wastewater, the emerging contaminants are mostly soluble organic matter, whereas the particulate matter and macromolecular organic substances are insoluble. Thus, although a catalytic ceramic membrane prepared based on a nanofiber catalyst or a single-atom catalyst can efficiently catalytically remove emerging contaminants in water and mitigate membrane fouling, the non-planar membrane surface and uneven pore size distribution of nanofiber catalytic ceramic membrane result in low separation efficiency and severe membrane fouling, making it impossible to achieve both high-efficiency separation and catalytic degradation functions simultaneously. For the single-atom catalytic ceramic membrane, although a membrane surface thereof is planar and a catalytic efficiency thereof is relatively high, enabling efficient removal of emerging contaminants and efficient separation of particulate matter and macromolecular organic matter in water, accumulation of the particulate matter and the macromolecular organic matter in water on the membrane surface is still unavoidable. Consequently, some catalytic active sites are covered, a utilization efficiency of the catalytic active sites is reduced, a generation efficiency of ROS is inhibited, and a trade-off limitation between a separation efficiency and a catalytic function of the catalytic ceramic membrane is formed.

### SUMMARY

An objective of the present disclosure is to overcome the deficiencies of the prior art and provide a preparation method of a ceramic membrane with high-efficiency separation and catalytic functions. A high-flux ceramic membrane support is prepared using large-particle-size ceramic particles as a raw material, an intermediate layer is prepared by a slurry dipping method using transition metal oxide nanofibers as a raw material, and a separation membrane layer is prepared by a dip-coating method using small-particle-size ceramic particles on this basis. The intermediate layer and the separation membrane layer are subjected to one-step co-firing to form a ceramic membrane having a sandwich structure and with high-efficiency separation and catalytic functions. Another objective of the present disclosure is to provide a product prepared by the preparation method of the ceramic membrane with high-efficiency separation and catalytic functions.

One or more embodiments of the present disclosure provide a preparation method of a ceramic membrane with high-efficiency separation and catalytic functions, comprising the following steps:

(a) preparation of a ceramic membrane support, including:
mixing coarse ceramic particles with an average particle size of 5 μm to 80 μm, a pore-forming agent, and a binder, and preparing the ceramic membrane support by a dry pressing method, and calcining at 1300 °C to 1650 °C for 2 h to 4 h to obtain the ceramic membrane support with an average pore size of 1 μm to 6 μm, wherein amounts of the pore-forming agent and the binder are respectively 5 wt % to 15 wt % and 0.5 wt % to 1.2 wt % of a weight of the coarse ceramic particles;

(b) preparation of an intermediate layer by a slurry dipping method, including:
adding transition metal oxide nanofibers with a diameter of 20 nm to 100 nm and an aspect ratio of 20 to 50, a dispersant, and a stabilizer into water, and stirring to obtain an intermediate layer slurry with a solid content of 10% to 20%, wherein amounts of the dispersant and the stabilizer are respectively 0.2 wt % to 0.8 wt % and 1.2 wt % to 2.5 wt % of a weight of the transition metal oxide nanofibers; and
immersing the ceramic membrane support into the intermediate layer slurry for an immersion time of 10 s to 30 s, with an immersion number of 1 to 5 times, and taking out and drying to obtain a ceramic membrane having the intermediate layer, wherein a membrane thickness of the intermediate layer is 60 μm to 150 μm;

(c) preparation of a separation membrane layer by a dip-coating method, including:
adding fine ceramic particles with an average particle size not greater than 500 nm, the dispersant, and the stabilizer into water, and stirring and ultrasonically dispersing to obtain a separation membrane layer slurry with a solid content of 15% to 25%, wherein amounts of the dispersant and the stabilizer are respectively 0.5 wt % to 1.5 wt % and 1.5 wt % to 3.5 wt % of a weight of the fine ceramic particles; and
immersing the ceramic membrane having the intermediate layer in the separation membrane layer slurry, and taking out and drying to obtain a ceramic membrane having the intermediate layer and the separation membrane layer; and

(d) preparation of a ceramic membrane, including:
subjecting the ceramic membrane having the intermediate layer and the separation membrane layer to calcination treatment at a calcination temperature of 900 °C to 1300 °C for a holding time of 1 h to 2 h to obtain a ceramic membrane with a porosity greater than 45% and a membrane pore size of 10 nm to 200 nm, which is a ceramic membrane with high-efficiency separation and catalytic functions.

One or more embodiments of the present disclosure provide a product prepared by the preparation method of the ceramic membrane with high-efficiency separation and catalytic functions according to the above embodiments.

### BRIEF DESCRIPTION OF THE DRAWINGS

The present disclosure will be further described in detail below with reference to examples and the accompanying drawings:

FIG. 1 is a scanning electron microscope (SEM) image of a membrane layer surface of the ceramic membrane prepared in Example 1 of the present disclosure.

FIG. 2 is a SEM image of a cross-section of the ceramic membrane prepared in Example 1 of the present disclosure.

### DETAILED DESCRIPTION

The present disclosure provides a preparation method of a ceramic membrane with high-efficiency separation and catalytic functions, and the method comprises the following steps:

### (a) Preparation of a Ceramic Membrane Support

The ceramic membrane support refers to a bottom layer structure of the ceramic membrane, which is configured to provide mechanical strength to the overall ceramic membrane and to carry the intermediate layer and the separation membrane layer.

In some embodiments, after mixing coarse ceramic particles with a pore-forming agent and a binder, a ceramic membrane support is prepared by a dry pressing method, and the obtained ceramic membrane support is calcined within a preset temperature range for a preset duration, to obtain the ceramic membrane support having a pore structure. The preset temperature range may be 1300 °C to 1650 °C, such as 1350 °C, 1450 °C, 1550 °C. The preset duration may be 2 h to 4 h, such as 2.5 h, 3.5 h.

The coarse ceramic particles may be ceramic particles with a relatively large particle size, e.g., ceramic particles with an average particle size of 5 μm to 80 μm. In some embodiments, the ceramic particles may include at least one of alumina, zirconia, silicon carbide, and cordierite.

In some embodiments, amounts of the pore-forming agent and the binder are respectively 5 wt % to 15 wt % and 0.5 wt % to 1.2 wt % of a weight of the coarse ceramic particles. For example, the amount of the pore-forming agent may be 7 wt %, 10 wt %, 12 wt %, or the like, of the weight of the coarse ceramic particles, and the amount of the binder may be 0.7 wt %, 0.9 wt %, 1.1 wt %, or the like, of the weight of the coarse ceramic particles.

In some embodiments, the pore-forming agent may include corn starch, charcoal powder, urea, or the like. The binder may include sodium carboxymethyl cellulose, polymethyl methacrylate, or the like.

Merely by way of example, coarse ceramic particles with an average particle size of 5 μm to 80 μm are mixed with the pore-forming agent and the binder, and then the ceramic membrane support is prepared by a dry pressing method and calcined at 1300 °C to 1650 °C for 2 h to 4 h, to obtain the ceramic membrane support with an average pore size of 1 μm to 6 μm.

### (b) Preparation of an Intermediate Layer by Slurry Dipping Method

The intermediate layer refers to an intermediate layer between the ceramic membrane support and the separation membrane layer and has a catalytic function.

In some embodiments, transition metal oxide nanofibers, a dispersant, and a stabilizer are added into water, and stirred to obtain an intermediate layer slurry with a solid content of 10% to 20%. The ceramic membrane support is immersed into the intermediate layer slurry and taken out and dried to obtain a ceramic membrane having the intermediate layer.

In some embodiments, amounts of the dispersant and the stabilizer are respectively 0.2 wt % to 0.8 wt % and 1.2 wt % to 2.5 wt % of a weight of the transition metal oxide nanofibers. For example, the amount of the dispersant may be 0.3 wt %, 0.5 wt %, 0.7 wt %, or the like, of the weight of the transition metal oxide nanofibers, and the amount of the stabilizer may be 1.6 wt %, 2.0 wt %, 2.4 wt %, or the like, of the weight of the transition metal oxide nanofibers.

In some embodiments, the transition metal oxide nanofibers may be at least one of manganese oxide fibers, titanium dioxide fibers, and iron oxide fibers. The transition metal oxide nanofibers may have a diameter of 20 nm to 100 nm (e.g., 40 nm or 80 nm) and an aspect ratio of 20 to 50 (e.g., 30 or 40).

In some embodiments, the ceramic membrane support is immersed into the intermediate layer slurry for an immersion time of 10 s to 30 s, with an immersion number of 1 to 5 times.

Merely by way of example, transition metal oxide nanofibers with a diameter of 20 nm to 100 nm and an aspect ratio of 20 to 50 are added with the dispersant and the stabilizer into water and stirred to obtain the intermediate layer slurry with a solid content of 10% to 20%. The ceramic membrane support is immersed into the intermediate layer slurry for an immersion time of 10 s to 30 s, with an immersion number of 1 to 5 times, and taken out and dried to obtain the ceramic membrane having the intermediate layer, wherein a membrane thickness of the intermediate layer is 60 μm to 150 μm.

### (c) Preparation of a Separation Membrane Layer by a Dip-Coating Method

The separation membrane layer refers to a top layer structure of the ceramic membrane, which is configured to separate water molecules from insoluble pollutants, such as sand and grit, metal slag, animal and plant residues.

In some embodiments, fine ceramic particles, the dispersant, and the stabilizer are added into water, and stirred and ultrasonically dispersed to obtain a separation membrane layer slurry with a solid content of 15% to 25%. The ceramic membrane having the intermediate layer is immersed in the separation membrane layer slurry and taken out and dried to obtain a ceramic membrane having the intermediate layer and the separation membrane layer.

The fine ceramic particles may be ceramic particles with a relatively small particle size, e.g., ceramic particles with an average particle size not greater than 500 nm.

In some embodiments, amounts of the dispersant and the stabilizer are respectively 0.5 wt % to 1.5 wt % and 1.5 wt % to 3.5 wt % of a weight of the fine ceramic particles. For example, the amount of the dispersant may be 0.7 wt %, 0.9 wt %, 1.2 wt %, or the like, of the weight of the fine ceramic particles, and the amount of the stabilizer may be 1.8 wt %, 2.4 wt %, 3.2 wt %, or the like, of the weight of the fine ceramic particles.

In some embodiments, the dispersant may be one or more of a Dolapix series dispersant, sodium hexametaphosphate, and polyethyleneimine. Since polyethyleneimine is a cationic polymeric dispersant, and the Dolapix series dispersant is an anionic dispersant, strong electrostatic attraction can occur when the two are co-present in a slurry system. This neutralization reaction of positive and negative charges can directly counteract the dispersion effects of the two. Therefore, polyethyleneimine cannot be formulated together with the Dolapix series dispersant, i.e., the dispersant cannot simultaneously include polyethyleneimine and the Dolapix series dispersant.

In some embodiments, the stabilizer may be at least one of sodium carboxymethyl cellulose, methylcellulose, and polyvinyl alcohol.

Merely by way of example, fine ceramic particles with an average particle size not greater than 500 nm are added with the dispersant and the stabilizer into water and stirred and ultrasonically dispersed to obtain the separation membrane layer slurry with a solid content of 15% to 25%. The ceramic membrane having the intermediate layer is immersed in the separation membrane layer slurry and taken out and dried to obtain the ceramic membrane having the intermediate layer and the separation membrane layer.

### (d) Preparation of a Ceramic Membrane

In some embodiments, the ceramic membrane having the intermediate layer and the separation membrane layer is subjected to the calcination treatment at a preset calcination temperature for a holding time of 1 h to 2 h, to obtain a ceramic membrane with high-efficiency separation and catalytic functions. The preset calcination temperature may be 900 °C to 1300 °C, such as 1000 °C or 1200 °C.

Merely by way of example, the ceramic membrane having the intermediate layer and the separation membrane layer is subjected to the calcination treatment at a calcination temperature of 900 °C to 1300 °C for a holding time of 1 h to 2 h, to obtain a ceramic membrane with a porosity greater than 45% and a membrane pore size of 10 nm to 200 nm, which is a ceramic membrane with high-efficiency separation and catalytic functions.

In some embodiments, the present disclosure further provides a product prepared by the preparation method of a ceramic membrane with high-efficiency separation and catalytic functions (i.e., the ceramic membrane).

In some embodiments, by using the ceramic membrane product, emerging contaminants in water are degraded through a continuous flow process of coupling or activating an oxidant. When a concentration of the emerging contaminants is 1 to 20 mg/L, an influent total organic carbon (TOC) is 5 to 25 mg/L, an influent chemical oxygen demand determined by potassium permanganate (COD_{Mn}) is 20 to 200 mg/L, an influent turbidity is 0.5 to 3.0 NTU, an influent ultraviolet absorbance at 254 nm (UV₂₅₄) is 0.1 to 1.8 cm⁻¹, a molar ratio of the oxidant to the emerging contaminants is 1: (0.03 to 0.1), and a membrane flux is 100 to 150 LMH, the degradation efficiency of the emerging contaminants is 100% during a continuous catalytic reaction for 1 to 24 h, and an effluent TOC of the membrane is 0 to 1.5 mg/L, an effluent COD_{Mn} is 0 to 20 mg/L, an effluent turbidity is 0 to 1.0 NTU, and an effluent UV₂₅₄ is 0 to 0.8 cm⁻¹.

In some embodiments, the oxidant applied in the present disclosure may be at least one of persulfate, hydrogen peroxide, ozone, and peroxyacetic acid, or the like. Emerging contaminants may include pharmaceuticals and personal care products such as bisphenol A, ibuprofen, sulfamethoxazole, tetracycline, and amoxicillin, endocrine disruptors, or the like.

The present disclosure uses the transition metal oxide nanofibers as the intermediate layer and uses the small particle size ceramic particles as the separation membrane layer. The intermediate layer formed by the transition metal oxide nanofibers has a relatively high porosity and specific surface area, thereby increasing a number of catalytic active sites, a generation rate of ROS, and a permeation flux. The separation membrane layer formed by the small particle size ceramic particles has a uniform pore size distribution and a flat membrane surface, thereby increasing a separation efficiency of particulate matter and organic matter in water, reducing accumulation thereof on the membrane surface, and alleviating membrane fouling. At the same time, coverage of catalytic active sites of the catalytic ceramic membrane by particulate matter and organic matter in water is avoided, thereby achieving simultaneous increase in the separation efficiency and the catalytic degradation efficiency of the ceramic membrane.

In the present disclosure, the transition metal oxide nanofibers are used as a raw material of an intermediate layer, which randomly stack to form a three-dimensional grid-like structure, effectively preventing the intermediate layer slurry from leaking into the ceramic membrane support. By controlling an immersion number to adjust the thickness of the intermediate layer, controllable preparation of the membrane layer is achieved. At the same time, an entangled structure is formed between the transition metal oxide nanofibers, thereby avoiding generation of cracks in the membrane layer, and providing a guarantee for the preparation of a high-performance separation membrane layer.

The present disclosure uses the slurry dipping method to prepare the intermediate layer and the separation membrane layer and uses a co-firing process of the intermediate layer and the separation membrane layer to prepare the ceramic membrane, thereby simplifying the preparation process and reducing the preparation cost of the catalytic ceramic membrane.

### EXAMPLE 1

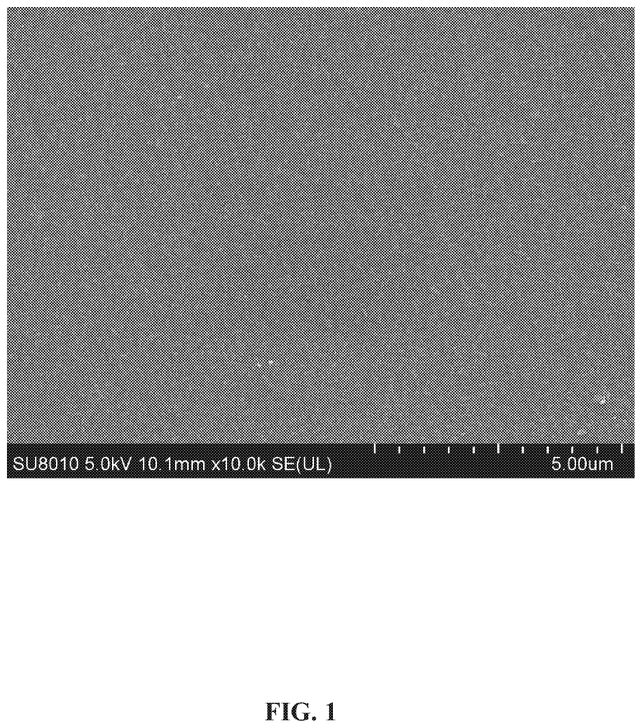

FIG. 1 is a SEM image of a membrane layer surface of a ceramic membrane prepared in Example 1 of the present disclosure.

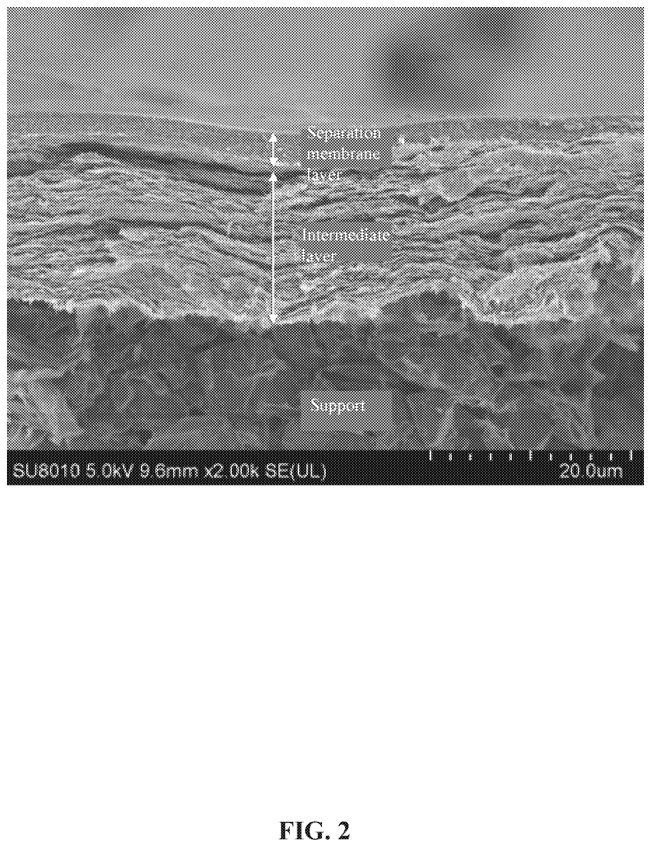

FIG. 2 is a SEM image of a cross-section of the ceramic membrane prepared in Example 1 of the present disclosure.

Example 1 provided a preparation method of a ceramic membrane with high-efficiency separation and catalytic functions. The method comprised the following steps:

### (1) Preparation of a Ceramic Membrane Support

100 g of coarse alumina particles with an average particle size of 20 μm were mixed with 10 g of corn starch and 0.8 g of sodium carboxymethyl cellulose, and then a ceramic membrane support was prepared by a dry pressing method (with a pressure of 12 MPa). The ceramic membrane support was calcined at 1450 °C for 3 h to obtain the ceramic membrane support with an average pore size of 2.5 μm (also referred to as the support).

### (2) Preparation of an Intermediate Layer by Slurry Dipping Method

10 g of titanium dioxide nanofibers with a diameter of 30 nm and a length of 800 nm were added with 0.05 g of sodium hexametaphosphate and 0.13 g of polyvinyl alcohol into 100 g of deionized water, and magnetically stirred for 30 min (at 300 r/min) to obtain an intermediate layer slurry.

The ceramic membrane support was immersed in the intermediate layer slurry for an immersion time of 25 s and an immersion number of 1 time and taken out and dried in a constant temperature and humidity drying oven (at a temperature of 90 °C and a humidity of 60%), to obtain a ceramic membrane having an intermediate layer.

### (3) Preparation of a Separation Membrane Layer by a Dip-Coating Method

15 g of fine alumina particles with an average particle size of 100 nm were added with 0.08 g of polyethyleneimine and 0.18 g of polyvinyl alcohol into 100 g of deionized water, magnetically stirred for 20 min (at 350 r/min), and ultrasonically dispersed for 5 min, to obtain a separation membrane layer slurry.

The ceramic membrane having an intermediate layer was immersed in the separation membrane layer slurry for an immersion time of 20 s and an immersion number of 1 time and taken out and dried in a constant temperature and humidity drying oven (at a temperature of 80 °C and a humidity of 50%), to obtain a ceramic membrane having an intermediate layer and a separation membrane layer.

### (4) Preparation of a Ceramic Membrane

The ceramic membrane having an intermediate layer and a separation membrane layer was placed in an electric furnace for the calcination treatment at a calcination temperature of 1100 °C for a holding time of 2 h, to obtain a ceramic membrane with high-efficiency separation and catalytic functions (see FIG. 1). The ceramic membrane has a porosity of 50% and an average pore size of 30 nm.

By using the ceramic membrane prepared in Example 1, ibuprofen in ultrapure water was degraded through a continuous flow process with peroxymonosulfate activation. The influent TOC is 5.5 mg/L, the influent COD_{Mn} is 25.5 mg/L, the influent turbidity is 0.72 NTU, and the influent UV₂₅₄ is 0.21 cm⁻¹. When the peroxymonosulfate concentration is 0.8 mM, an ibuprofen concentration is 10 mg/L, and a membrane flux is 100 LMH, the degradation efficiency of ibuprofen is 100% during a continuous catalytic reaction for 12 h, the effluent TOC of the membrane is 0.5 mg/L, the effluent COD_{Mn} is 5.8 mg/L, the effluent turbidity is 0.51 NTU, and the effluent UV₂₅₄ is 0.13 cm⁻¹.

### EXAMPLE 2

Example 2 provided a preparation method of a ceramic membrane with high-efficiency separation and catalytic functions. The method comprised the following steps:

### (1) Preparation of a Ceramic Membrane Support

100 g of coarse alumina particles with an average particle size of 40 μm were mixed with 10 g of corn starch and 0.8 g of sodium carboxymethyl cellulose, and then a ceramic membrane support was prepared by a dry pressing method (with a pressure of 12 MPa). The ceramic membrane support was calcined at 1550 °C for 2 h to obtain the ceramic membrane support with an average pore size of 3.2 μm.

### (2) Preparation of an Intermediate Layer by Slurry Dipping Method

10 g of manganese oxide nanofibers with a diameter of 40 nm and a length of 900 nm were added with 0.05 g of sodium hexametaphosphate and 0.13 g of polyvinyl alcohol into 100 g of deionized water, and magnetically stirred for 30 min (at 300 r/min) to obtain an intermediate layer slurry.

The ceramic membrane support was immersed in the intermediate layer slurry for an immersion time of 25 s and an immersion number of 1 time and taken out and dried in a constant temperature and humidity drying oven (at a temperature of 90 °C and a humidity of 60%), to obtain a ceramic membrane having an intermediate layer.

### (3) Preparation of a Separation Membrane Layer by a Dip-Coating Method

15 g of alumina fine particles with an average particle size of 200 nm were added with 0.08 g of polyethyleneimine and 0.18 g of polyvinyl alcohol into 100 g of deionized water, magnetically stirred for 20 min (at 350 r/min), and ultrasonically dispersed for 5 min, to obtain a separation membrane layer slurry.

The ceramic membrane having an intermediate layer was immersed in the separation membrane layer slurry for an immersion time of 20 s and an immersion number of 1 time and taken out and dried in a constant temperature and humidity drying oven (at a temperature of 80 °C and a humidity of 50%), to obtain a ceramic membrane having an intermediate layer and a separation membrane layer.

### (4) Preparation of a Ceramic Membrane

The ceramic membrane having an intermediate layer and a separation membrane layer was placed in an electric furnace for the calcination treatment at a calcination temperature of 1200 °C for a holding time of 2 h, to obtain a ceramic membrane with high-efficiency separation and catalytic functions. The ceramic membrane has a porosity of 55% and an average pore size of 50 nm.

By using the ceramic membrane prepared in Example 2, bisphenol A in surface water was degraded through a continuous flow process with peroxymonosulfate activation. The influent turbidity is 2.1 NTU, the influent TOC is 15 mg/L, the influent COD_{Mn} is 120 mg/L, and the influent UV₂₅₄ is 1.2 cm⁻¹. When the peroxymonosulfate concentration is 1.0 mM, an ibuprofen concentration is 15 mg/L, and a membrane flux is 120 LMH, the degradation efficiency of bisphenol A is 100% during a continuous catalytic reaction for 12 h, the effluent turbidity of the membrane is 0.5 NTU, the effluent TOC is 1.5 mg/L, the effluent COD_{Mn} is 25 mg/L, and the effluent UV₂₅₄ is 0.21 cm⁻¹.

What is claimed is:

1. A preparation method of a ceramic membrane with high-efficiency separation and catalytic functions, comprising:
(a) preparation of a ceramic membrane support, including:
mixing coarse ceramic particles with an average particle size of 5 μm to 80 μm, a pore-forming agent, and a binder, and preparing the ceramic membrane support by a dry pressing method, and calcining the ceramic membrane support at 1300 °C to 1650 °C for 2 h to 4 h to obtain the ceramic membrane support with an average pore size of 1 μm to 6 μm, wherein amounts of the pore-forming agent and the binder are respectively 5 wt % to 15 wt % and 0.5 wt % to 1.2 wt % of a weight of the coarse ceramic particles;
(b) preparation of an intermediate layer by a slurry dipping method, including:
adding transition metal oxide nanofibers with a diameter of 20 nm to 100 nm and an aspect ratio of 20 to 50, a dispersant, and a stabilizer into water, and stirring to obtain an intermediate layer slurry with a solid content of 10% to 20%, wherein amounts of the dispersant and the stabilizer are respectively 0.2 wt % to 0.8 wt % and 1.2 wt % to 2.5 wt % of a weight of the transition metal oxide nanofibers; and
immersing the ceramic membrane support into the intermediate layer slurry for an immersion time of 10 s to 30 s, with an immersion number of 1 to 5 times, and taking out and drying to obtain a ceramic membrane having the intermediate layer, wherein a membrane thickness of the intermediate layer is 60 μm to 150 μm;
(c) preparation of a separation membrane layer by a dip-coating method, including:
adding fine ceramic particles with an average particle size not greater than 500 nm, a dispersant, and a stabilizer into water, and stirring and ultrasonically dispersing to obtain a separation membrane layer slurry with a solid content of 15% to 25%, wherein amounts of the dispersant and the stabilizer are respectively 0.5 wt % to 1.5 wt % and 1.5 wt % to 3.5 wt % of a weight of the fine ceramic particles; and
immersing the ceramic membrane having the intermediate layer in the separation membrane layer slurry, and taking out and drying to obtain a ceramic membrane having the intermediate layer and the separation membrane layer; and
(d) preparation of a ceramic membrane, including:
subjecting the ceramic membrane having the intermediate layer and the separation membrane layer to calcination treatment at a calcination temperature of 900 °C to 1300 °C for a holding time of 1 h to 2 h to obtain a ceramic membrane with a porosity greater than 45% and a membrane pore size of 10 nm to 200 nm, which is a ceramic membrane with high-efficiency separation and catalytic functions.

2. The preparation method of the ceramic membrane with high-efficiency separation and catalytic functions according to claim 1, wherein the coarse ceramic particles and the fine ceramic particles are at least one of alumina, zirconia, silicon carbide, and cordierite.

3. The preparation method of the ceramic membrane with high-efficiency separation and catalytic functions according to claim 1, wherein the transition metal oxide nanofibers are at least one of manganese oxide fibers, titanium dioxide fibers, and iron oxide fibers.

4. The preparation method of the ceramic membrane with high-efficiency separation and catalytic functions according to claim 1, wherein the dispersant is one or more of a Dolapix series dispersant, sodium hexametaphosphate, and polyethyleneimine, wherein the polyethyleneimine cannot be formulated together with the Dolapix series dispersant; and the stabilizer is at least one of sodium carboxymethyl cellulose, methylcellulose, and polyvinyl alcohol.

5. A product prepared by the preparation method of the ceramic membrane with high-efficiency separation and catalytic functions according to claim 1.
